(19) United States
(12) Patent Application Publication
(10) Pub. No.: US 2007/0103539 A1
(43) Pub. Date: May 10, 2007

(54) Print head and image forming apparatus employing the print head

(75) Inventor: Woon-ho Seo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/517,433

(22) Filed: Sep. 8, 2006

(30) Foreign Application Priority Data
Nov. 4, 2005 (KR) 10-2005-0105472

(51) Int. Cl. G01D 15/14

(52) U.S. Cl. 347/230

(57) ABSTRACT

A print head is provided using a liquid crystal microlens array and an image forming apparatus is provided to employ the print head. The print head, which forms a latent image by selectively emitting light to respective image points of a photoconductor, includes an illumination unit to emit the light, and a liquid crystal microlens array interposed between the illumination unit and the photoconductor. The liquid crystal microlens array selectively condenses a portion of the light emitted from the illumination unit and directed to image points corresponding to the latent image on the photoconductor. The image forming apparatus includes a photoconductor to form a latent image thereon, the print head forming the latent image by selectively emitting light to respective image points of the photoconductor, a developing unit to supply developer to the photoconductor to form a developer image corresponding to the latent image, a transfer unit to transfer the developer image formed on the photoconductor to a printing medium, and a fusing unit to fuse the developer image to the printing medium.

### CROSS-REFERENCE TO RELATED PATENT APPLICATION

This application claims the benefit of Korean Patent Application No. 10-2005-0105472, filed on Nov. 4, 2005, in the Korean Intellectual Property Office, the disclosure of which is hereby incorporated by reference in its entirety.

### BACKGROUND OF THE INVENTION

1. Field of the Invention

The present invention relates to a print head and an image forming apparatus employing the print head. More particularly, the invention is directed to a print head using a liquid crystal microlens array and to an image forming apparatus employing the print head.

2. Description of the Related Art

Generally, an electrophotographic image forming apparatus scans a photoconductor with a laser beam to expose an image forming part of the photoconductor to form an electrostatic latent image. Toner is supplied between the photoconductor and a developing roller disposed beside the photoconductor a predetermined distance in order to selectively attach the supplied toner to the image forming part by utilizing the electrical property.

Such an electrophotographic image forming apparatus utilizes a laser beam, which requires a laser scanning unit to project a laser beam. However, the laser scanning unit requires a precise and very expensive optical arrangement.

As a way of configuring the image forming apparatus without the laser scanning unit, a print head having a structure as shown in FIG. 1 is provided in prior devices.

Referring to FIG. 1, the conventional print head includes a semiconductor light emitting device array (hereinafter, referred to as an LED array 1) having a plurality of LEDs, and a SELFOC lens array 5 condensing light emitted from the respective LEDs of the LED array 1 to image the light corresponding to the respective LEDs on a photoconductor. Here, the SELFOC lens is a kind of gradient index (GRIN) lens operating by an ion exchange method, for example, an ion exchange between SiO₂ and Ag.

According to an image signal from a main controller, the print head turns on/off the respective LEDs of the LED array 1 independently to a predetermined current level by means of driving chips 3. Here, light emitted from on-state LEDs are condensed by the SELFOC lens array 5 and projected to the photoconductor to form a latent image 7.

Meanwhile, when the print head forms the latent image 7 on the photoconductor by turning on/off the LEDs according to the input image signal, the amount of light emitted from a light emitting point of the respective LEDs deviate. To compensate for the light output deviation, each time a line is scanned in a main scanning direction, each light emitting point is on/off operated with reference to a preset current level corresponding to the light emitting point, making the amount of light of each light emitting point uniform. However, this complicates the configuration of a driving circuit. Further, if a current consumption difference increases suddenly according to an input image signal, like the case when white lines are scanned after black lines are scanned, a surge effect rises to cause damages to the circuitry.

An alternative way of configuring the image forming apparatus without the laser scanning unit is disclosed in U.S. Pat. No. 6,825,865, entitled “PRINT HEAD WITH LIQUID CRYSTAL SHUTTER.”

The disclosed print head, which uses a white light source, or red, blue, and green light sources and includes a liquid crystal shutter for each light source, is configured to pass red, blue, and green light through corresponding regions of a photoconductive film according to a voltage. Light transmitted through the liquid crystal shutter is transmitted through a SELFOC lens array via a reflector and then transmitted through a prism to form an image on the photosensitive film.

Such a print head with the liquid crystal shutter uses a SELFOC lens array and a prism for securing an optical path and focusing complicating mechanical and optical structures.

### SUMMARY OF THE INVENTION

The present invention provides a print head that obviates a problem of compensating for light output deviation. The invention also obviates the surge problem rising in an LED print head. The invention is also directed to an image forming apparatus employing the print head.

According to an aspect of the present invention, a print head is provided to form a latent image by selectively emitting light to respective image points of a photoconductor. The print head includes: an illumination unit to emit the light; and a liquid crystal microlens array interposed between the illumination unit and the photoconductor. The liquid crystal microlens array selectively condenses a portion of the light emitted from the illumination unit and directed to image points corresponding to the latent image, onto the photoconductor.

According to another aspect of the present invention, an image forming apparatus is provided including: a photoconductor to form a latent image thereon; a print head to form the latent image by selectively emitting light to respective image points of the photoconductor. The print head includes an illumination unit to emit the light, and a liquid crystal microlens array interposed between the illumination unit and the photoconductor to selectively condense a portion of the light emitted from the illumination unit and directed to image points corresponding to the latent image, onto the photoconductor. The apparatus includes a developing unit to supply developer to the photoconductor to form a developer image corresponding to the latent image; a transfer unit to transfer the developer image formed on the photoconductor to a printing medium; and a fusing unit to fuse the developer image to the printing medium.

These and other aspects of the invention will become apparent from the following detailed description of the invention, which taken in conjunction with the annexed drawings, disclose embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a conventional LED print head utilizing a SELFOC lens array;

FIG. 2 is a schematic perspective view of a print head according to an embodiment of the present invention;

FIG. 3 is a partial cross-sectional view schematically showing a print head according to an embodiment of the present invention;

FIG. 4 is a partial cross-sectional view schematically showing a print head according to another embodiment of the present invention; and

FIG. 5 is a schematic view of an image forming apparatus employing a print head according to an embodiment of the present invention.

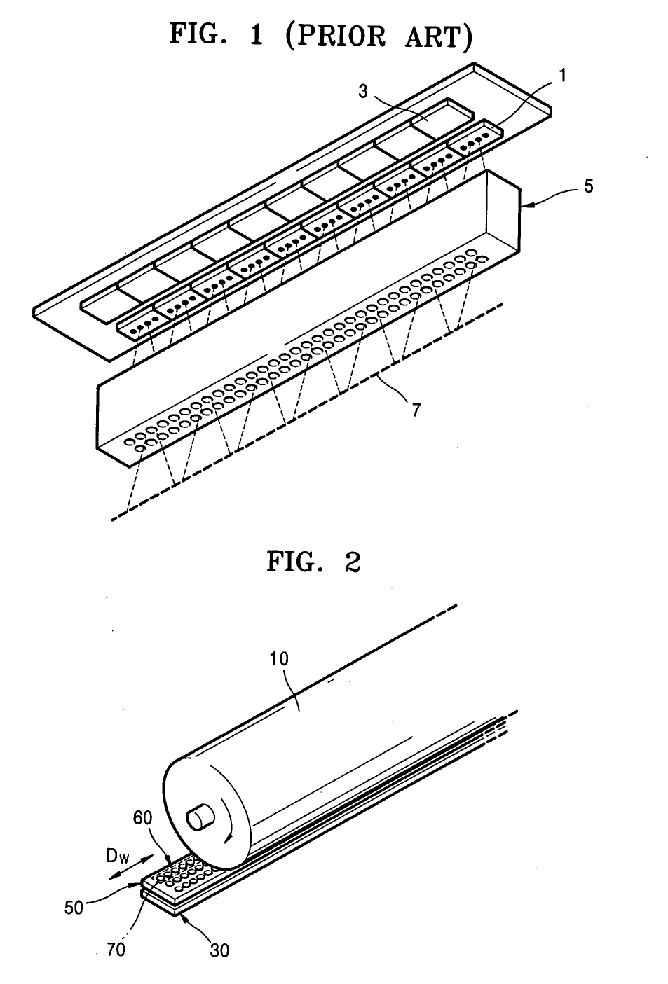

### DETAILED DESCRIPTION OF THE INVENTION

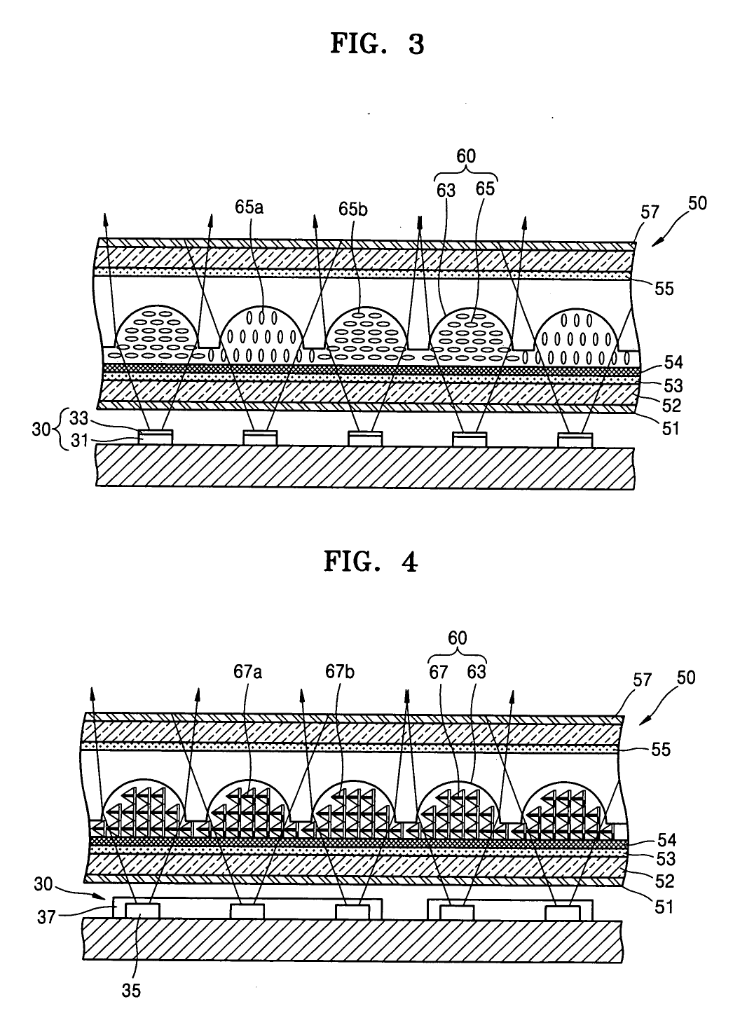

FIG. 2 is a schematic perspective view of a print head according to an embodiment of the present invention. FIGS. 3 and 4 are schematic partial cross-sectional views of FIG. 2, respectively.

Referring to FIGS. 2 through 4, the print head of an embodiment of the present invention forms a latent image by selectively project light onto image points of a photoconductor 10. The print head includes an illumination unit 30 to emit light continuously during printing, and a liquid crystal microlens array 50 interposed between the illumination unit 30 and the photoconductor 10. The liquid crystal microlens array 50 selectively condenses incident light from the illumination unit 30 onto the photoconductor 10 such that image points of the photoconductor 10 corresponding to the latent image can be selectively scanned.

Unlike the conventional LED array of the print head, the illumination unit 30 continuously emits light having a predetermined wavelength onto the photoconductor 10 regardless of an input image signal during printing.

Referring to FIG. 3, an illumination unit 30 of an embodiment includes a white light source 31 to emit white light, and a color filter 33 to selectively transmit the white light emitted from the white light source 31 in a manner such that light is transmitted having a particular wavelength to which the photoconductor 10 is sensitive. The white light source 31 may be formed using an LED array configured with LEDs or organic LEDs (OLEDs), a fluorescent lamp such as a cold cathode fluorescent lamp (CCFL), or a xenon lamp.

Referring to FIG. 4, an illumination unit 30 of another embodiment may include a light source 35 to continuously emit a high intensity light and a predetermined wavelength to which the photoconductor 10 is sensitive during printing, and a guide plate 37 to guide the light emitted from the light source 35 to the liquid crystal microlens array 50.

As shown in FIG. 4, the liquid crystal microlens array 50 includes a transparent substrate 52, a plurality of liquid crystal microlenses 60 arranged above the transparent substrate 52, an alignment layer 54 formed on a side of the liquid crystal microlenses 60, first and second transparent electrodes 53 and 55, and first and second polarizers 51 and 57.

The liquid crystal microlenses 60 are arranged in a width direction D_{w} of the photoconductor 10, making up a lens array 70 as shown in FIG. 2. The lens array 70 can simultaneously form a line of a latent image on the photoconductor 10 in the width direction D_{w}, and then, sequentially form the next line of the latent image when the photoconductor 10 is relatively advanced with respect to the lens array 70. Meanwhile, as shown in FIG. 2, a plurality of lens arrays 70 may be provided in an advancing direction of the photoconductor 10. In this case, a plurality of width lines of a latent image (three lines in case of FIG. 2) can be simultaneously formed along the advancing direction of the photoconductor 10.

Referring to FIGS. 3 and 4, each of the liquid crystal microlenses 60 includes a lens portion 63 to condense incident light and liquid crystals 65 and 67 filled in the lens portion 63. The liquid crystal may be formed of nematic liquid crystal 65 or ferroelectric liquid crystal 67 as shown in FIGS. 3 and 4, respectively.

Referring to FIG. 3, the nematic liquid crystal 65 is formed in the lens portion 63 in a multi-layer fashion. Dipoles of the nematic liquid crystal 65 are arranged between a vertical direction 65a and a horizontal direction 65b according to a voltage applied through the first and second transparent electrodes 53 and 55. Here, the response time of the nematic liquid crystal 65 ranges on the order of several hundreds of micro seconds to several milliseconds. On the contrary, in the image forming apparatus, a time required for each light emitting point to scan an image point of the photoconductor 10 is several tens to several micro seconds. Therefore, since the response time of the nematic liquid crystal 65 is greater than the required scanning time, it is difficult to use the nematic liquid crystal 65 for a print head configured to simultaneously form a single latent image line. Meanwhile, as explained above, by configuring the print head to simultaneously form a plurality of latent image lines, the scanning time required in the image forming apparatus can be satisfied even when the nematic liquid crystal 65 having a relatively slow operating characteristic is used.

Referring to FIG. 4, molecules of the ferroelectric liquid crystal 67 are arranged in a vertically erected layer fashion, and when a voltage is applied, corresponding molecular dipoles of each layer are spun in cone shapes 67a and 67b to change the polarizing direction. Therefore, refraction index of the liquid crystal microlens 60 changes. In this case, since on/off operation of the ferroelectric liquid crystal 67 is performed on the order of several micro seconds, the required scanning time of the image forming apparatus can be satisfied by configuring the print head to simultaneously form only a single latent image line.

Meanwhile, the liquid crystal microlenses 60 can be formed in desired outer shapes by adjusting deviation of the amount of ultraviolet light expose by using anisotropic separation, polymer dispersion, or polymer stabilization that exposes photocurable polymer and liquid crystal solution to ultraviolet light. For example, the structure of a liquid crystal microlens is disclosed in “Fabrication of Electrically Controllable Array Using Liquid Crystals”, Jae-Hoon Kim and Satyendra Kumar, Journal Of Lightwave Technology, Vol. 23, No. 2, pp. 628-632(February 2005), and “Fast Switchable and Bistable Microlens Array Using Ferroelectric Liquid Crystals”, Jae-Hoon Kim and Satyendra Kumar, Japanese Journal of Applied Physics, Vol. 43, No. 10, pp. 7050-7053(2004). Thus, a detailed description thereof will be omitted.

The alignment layer 54, which is formed on one side of the liquid crystal microlenses 60, determines the alignment direction of the liquid crystals 65 and 67. Therefore, when the liquid crystal microlens 60 is not operated, the liquid crystals 65 and 67 is arranged in a direction determined by the alignment layer 54.

The first and second transparent electrodes 53 and 55 are provided under and above the liquid crystal microlenses 60, respectively. The first and second transparent electrodes 53 and 55 apply power to the plurality of liquid crystal microlenses 60 independently, such that liquid crystal alignment can be selectively changed with respect to image points of the photoconductor 10 where a latent image is formed.

The first and second polarizers 51 and 57 are provided under and above the liquid crystal microlenses 60, respectively. The first and second polarizers 51 and 57 transmit incident light only having a particular polarization. Here, if the illumination unit 30 emits light having a particular polarization, the first polarizer 51 can be omitted.

An operation of the print head having the above-described structure will now be described.

During printing, the illumination unit 30 continuously emits lights having a predetermined wavelength toward the liquid crystal microlens array 50 regardless of an input image signal. The first polarizer 51 transmits only a particular polarization component of the light incident from the illumination unit 30 and blocks the other polarization components of the incident light.

The liquid crystal dipoles of the respective liquid crystal microlenses 60 are independently aligned by power applied to the first and second transparent electrodes 53 and 55. Here, the polarization direction and refraction index of the respective lens portions 63 are changed according to the dipole alignment direction of the liquid crystal 65 and 67. That is, since the liquid crystals 65 and 67 is characterized by the fact that refraction index of the liquid crystals 65 and 67 in an ordinary ray axis is different from that in an extra-ordinary ray axis, the refraction index varies between the two refraction index values according to the degree of applied voltage. Therefore, the respective liquid crystal microlenses 60 transmit incident diffusion light while condensing the diffusion light to different degrees depending on whether a voltage is applied or not. For example, when power is applied, the liquid crystal of the liquid crystal microlens 60 is aligned as shown with reference numerals 65b and 67b, such that incident light can be condensed much more while passing through the liquid crystals 65b and 67b. Meanwhile, when power is not applied, the liquid crystal of the liquid crystal microlens 60 is aligned as shown by reference numerals 65a and 67a, such that the incident light can be straightly transmitted straight through the liquid crystals 65a and 67a or slightly condensed while transmitted through the liquid crystals 65a and 67a.

The second polarizer 57 transmits only a particular polarization component of the light transmitted through the liquid crystal microlenses 60 toward the photoconductor 10. Therefore, condensed light can be selectively projected to image points of the photoconductor 10 where a latent image to be formed, and light emitted to other regions of the photoconductor 10 can be excluded.

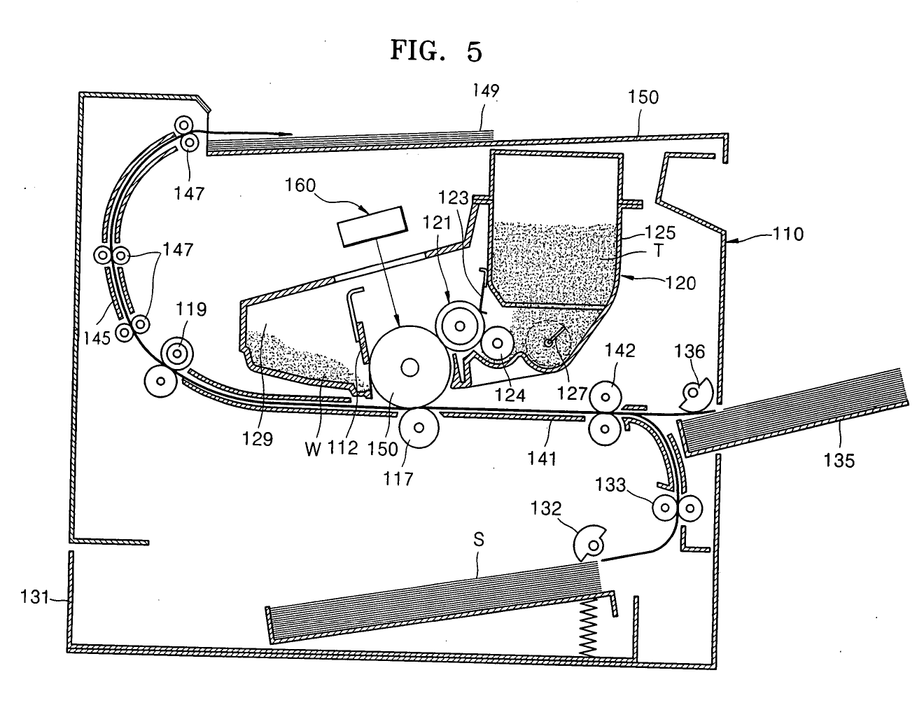

FIG. 5 is a schematic view of an image forming apparatus employing a print head according to the present invention.

Referring to FIG. 5, the image forming apparatus employing the print head according to an embodiment of the present invention includes a cabinet 110, a photoconductor 150 provided in the cabinet 110, a print head 160, a developing unit 120, a transfer roller 117, and a fusing roller 119.

The print head 160 forms a latent image on image points of the photoconductor 150 according to an image to be printed. Here, the print head 160 is constructed substantially in the same way as shown in FIGS. 2 through 4. Thus, a detailed-description will not be repeated.

The developing unit 120 contains developer (T) in a container 125, and supplies the developer (T) to the photoconductor 150 through an agitator 127, a supplying roller 124, and a developer roller 121 to develop the latent image of the photoconductor 150. A doctor blade 123 is provided on a circumference of the developer roller 121 to regulate the developer (T) supplied to the developer roller 121. In the developing unit 120 configured as described above, the developer (T) forms a developer layer having a constant thickness as it passes between the doctor blade 123 and the developer roller 121. A waste developer container 129 is provided in the developer unit 120 to store waste toner (W) collected by a cleaning blade 112 after developing.

As explained above, the developer image formed on the photoconductor 150 by the developing unit 120 is transferred to a printing medium (S) fed between the photoconductor 150 and the transfer roller 117, and the transferred developer image is fused to the printing medium (S) by the fusing rollers 119.

Further, the image forming apparatus, which prints an image on a printing medium (S) fed from a first cassette 131 or a second cassette 135, includes a printing media feeding passage 141 and a printing media output passage 145. Along the printing media feeding passage 141, the image forming apparatus includes pick-up rollers 132 and 136 picking up printing media (S) one by one, feed rollers 133 guiding the feeding of the pick-up printing media (S), and registration rollers 142 to print an image on the printing medium (S) at a desired region. Along the printing media output passage 145, the image forming apparatus includes the fusing rollers 119 and a plurality of eject rollers 147.

Therefore, the developer image formed on the photoconductor 150 is transferred to the printing media (S), which is supplied from the first cassette 131 or the second cassette 135 and fed along the printing media feeding passage 141, and then the transferred developer image is fused to the printing medium (S) by the fusing roller 119. After an image is completely formed on the printing medium (S) in this way, the printing medium (S) is stacked in an output tray 149 formed on a top of the cabinet 110 through the printing media output passage 145, completing the printing process.

The print head configured as described above according to the present invention and the image forming apparatus employing the print head can fundamentally solve the surge problem of the conventional LED print head caused by sudden current change by continuously operating the illumination unit during printing. Further, since a region on which an image is to be formed can be selectively illuminated by on/off controlling the first and second electrodes using a driving method used for a typical liquid crystal display, designing an additional driving circuit is not necessary for controlling the operation of the illumination unit.

Furthermore, since the print head utilizes the liquid crystal microlens array that has a liquid crystal shutter function for selectively transmitting incident light and an incident light condensing function, the print head can have a more compact structure than the conventional print head that utilizes a combination of a SELFOC lens array and a prism for condensing light and securing an optical path.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A print head for forming a latent image by selectively emitting light to respective image points of a photoconductor, the print head comprising:
an illumination unit to emit the light; and
a liquid crystal microlens array interposed between the illumination unit and the photoconductor, the liquid crystal microlens array selectively condensing a portion of the light emitted from the illumination unit and directing to image points corresponding to the latent image onto the photoconductor.

2. The print head of claim 1, wherein the liquid crystal microlens array comprises:
a transparent substrate;
a plurality of liquid crystal microlenses arranged above the transparent substrate, each of the liquid crystal microlenses including a lens portion condensing incident light and liquid crystal filling in the lens portion;
an alignment layer formed on a side of the plurality of liquid crystal microlenses and determining an alignment direction of the liquid crystal;
a first transparent electrode and a second transparent electrode provided under and above the liquid crystal microlenses, respectively, the first and second transparent electrodes applying power to a respective liquid crystal microlens independently for changing the alignment direction of the liquid crystal; and
a first polarizer and a second polarizer provided under and above the liquid crystal microlenses, respectively, for transmitting light having a particular polarization.

3. The print head of claim 2, wherein the liquid crystal microlenses are arranged in a width direction with respect to the photoconductor to form a lens array, and the lens array simultaneously forms a single image line with respect to the width direction of the photoconductor.

4. The print head of claim 3, wherein a plurality of lens arrays is provided along an advancing direction of the photoconductor, for simultaneously forming a plurality of latent image lines in the width direction of the photoconductor along the advancing direction of the photoconductor.

5. The print head of claim 2, wherein the liquid crystal is formed of nematic liquid crystal or ferroelectric liquid crystal.

6. The print head of claim 1, wherein the illumination unit comprises:
a white light source to continuously emit white light during printing; and
a color filter to transmit only a predetermined wavelength of the white light to which the photoconductor is sensitive.

7. The print head of claim 6, wherein the white light source is a light source selected from the group consisting of a light emitting diode array, a fluorescent lamp, and a xenon lamp.

8. The print head of claim 1, wherein the illumination unit comprises:
a light source to continuously emit light having a predetermined wavelength to which the photoconductor is sensitive during printing; and
an optical guide plate guide the light emitted from the light source toward the liquid crystal microlens array.

9. An image forming apparatus comprising:
a photoconductor to form a latent image thereon;
a print head form the latent image by selectively emitting light to respective image points of the photoconductor, the print head including an illumination unit emitting the light, and a liquid crystal microlens array interposed between the illumination unit and the photoconductor to selectively condense a portion of the light emitted from the illumination unit and directed to image points corresponding to the latent image onto the photoconductor;
a developing unit supply developer to the photoconductor for forming a developer image corresponding to the latent image;
a transfer unit transfer the developer image formed on the photoconductor to a printing medium; and
a fusing unit to fuse the developer image to the printing medium.

10. The image forming apparatus of claim 9, wherein the liquid crystal microlens array comprises:
a transparent substrate;
a plurality of liquid crystal microlenses arranged above the transparent substrate, each of the liquid crystal microlenses including a lens portion to condense incident light and liquid crystal filling in the lens portion;
an alignment layer formed on a side of the plurality of liquid crystal microlenses and determining an alignment direction of the liquid crystal;
a first transparent electrode and a second transparent electrode provided under and above the liquid crystal microlenses, respectively, the first and second transparent electrodes applying power to the respective liquid crystal microlenses independently to change the alignment direction of the liquid crystal; and
a first polarizer and a second polarizer provided under and above the liquid crystal microlenses, respectively, to transmit light having a particular polarization.

11. The image forming apparatus of claim 10, wherein the liquid crystal microlenses are arranged in a width direction with respect to the photoconductor in a direction perpendicular to a moving direction of the photoconductor to form a lens array, and the lens array simultaneously forms a single image line with respect to the width direction of the photoconductor.

12. The image forming apparatus of claim 11, wherein a plurality of lens arrays is provided along an advancing direction of the photoconductor, to simultaneously form a plurality of latent image lines in the width direction of the photoconductor along the advancing direction of the photoconductor.

13. The image forming apparatus of claim 10, wherein the liquid crystal is formed of nematic liquid crystal or ferroelectric liquid crystal.

14. The image forming apparatus of claim 9, wherein the illumination unit comprises:
a white light source to continuously emit white light during printing; and
a color filter to transmit only a predetermined wavelength of the white light to which the photoconductor is sensitive.

15. The image forming apparatus of claim 14, wherein the white light source is a light source selected from the group consisting of a light emitting diode array, a fluorescent lamp, and a xenon lamp.

16. The image forming apparatus of claim 9, wherein the illumination unit comprises:
a light source to continuously emit light having a predetermined wavelength to which the photoconductor is sensitive during printing; and
an optical guide plate coupled to the light source, the optical guide plate guiding the light emitted from the light source toward the liquid crystal microlens array.
